(19) United States
(12) Patent Application Publication
(10) Pub. No.: US 2002/0159859 A1
(43) Pub. Date: Oct. 31, 2002

(54) Conical fastener assembly

(76) Inventor: Salvatore J. Sisto, East Brunswick, NJ (US)

Correspondence Address: GOTTLIEB RACKMAN & REISMAN PC, 270 MADISON AVENUE, 8TH FLOOR, NEW YORK, NY, 100160601

(21) Appl. No.: 09/942,985

(22) Filed: Aug. 30, 2001

Related U.S. Application Data
(60) Provisional application No. 60/228,987, filed on Aug. 30, 2000.

(51) Int. Cl. F16B 21/00

(52) U.S. Cl. 411/340

(57) ABSTRACT

A fastener assembly which imparts, on a surface of a first structural element to be joined to a second structural element, joining forces at the base of a cone isolated from the edge of an opening extending through the first structural element. An illustrative embodiment of the fastener assembly includes an apertured face plate, an anchoring assembly, and a positioner for causing relative axial movement between the face plate and the anchoring assembly. The anchoring assembly includes a base portion and a projecting portion that extends in an axial direction away from the base portion. The projecting portion of the anchoring assembly is sufficiently rigid as to restrict further movement of the base portion toward the face plate when the projecting portion initially contacts the first structural element, despite continued actuation of the positioner, and the projecting portion is sufficiently rigid as to prevent displacement of distal regions of the anchoring assembly from respective initial positions of contact with the radially equidistant regions on the first structural element--despite progressively increased exertion of a pulling force on the anchoring assembly by the positioner.

This application claims priority of provisional application No. 60/228,987 filed Aug. 30, 2000.

### BACKGROUND OF THE INVENTION

1. Field of the Invention

A fastener that can be readily adapted to interconnect a wide variety of objects and structural elements.

2. Description of the Background Art

Over the years, a vast array of fasteners have been proposed, with each being cited as having one or more advantages that make it suitable for a given application or installation.

One problem associated with fasteners is that stress exerted by heavy objects attached to the fastener on the outside of the wall may cause the fastener to pull outwardly through the wall. Another problem is that the fasteners must be carefully installed to ensure that they are not over-torque. Continued twisting of the threaded bolt or screw after the anchoring mechanism has contacted the inner surface of the wall will cause the anchoring mechanism to twist and dig into the inner surface of the wall. This digging action gouges the periphery of the wall hole, which causes the fastener to fit loosely within the wall and thereby increases the likelihood that the fastener will become dislodged from the wall.

Additionally, the supporting capacity/strength of conventional fastening structures is limited by a relatively short axis of rotation in the axial plane. As will be readily appreciated by those skilled in the art, this axis is defined by the distance between the points of support provided by the anchoring assembly and threaded member. In the case of prior art configurations such, for example, as the “molly” bolt, this distance is equivalent to the thickness of the wall or wallboard and is typically far too short to support large or heavy objects due to the high concentration of stresses over such a small area.

Another type of blind fastener, the rivet, is most often used where two or more overlapping planar elements are to be joined. For example, in the construction of modem aircraft, rivets are typically used to join the individual sheets of aluminum that collectively form a skin over the air frame. In such an environment, it is usually permissible for the adjacent rivets to be separated by the preferred spacing of one rivet diameter. Rivets have also be employed in the construction of more advanced aircraft that require the joining of complex control surfaces of graphite or other composite materials. Due to stress concentrations adjacent the holes in such materials, however, the inter—rivet spacing must be increased to four rivet diameters—thereby limiting the joining forces that may be applied. Extremely close tolerances must also be observed in order to ensure a reliable attachment.

### SUMMARY OF THE INVENTION

The deficiencies associated with the prior art are avoided by a fastener assembly in which joining forces are imparted at the annular base of a cone located away from the peripheral edges of aligned openings in respective elements to be fastened. In this manner, stress concentrations at the periphery of the aligned openings are substantially avoided. It is contemplated that fasteners constructed in accordance with the teachings of the present invention may be employed in connection with the support of relatively heavy objects on such diverse structural assemblies as prefabricated walls such as are found in prefabricated shower stalls, metal frame members, channels and panel members, concrete and cinder block structures, where there is access to both sides of the structure, as well as other structures which will become apparent to the artisan of ordinary skill. It is further contemplated that fasteners constructed in accordance with the present invention may be utilized as an alternative to the rivet as a means to secure overlapping sheets or panels of material.

A fastener constructed in accordance with an illustrative embodiment of the present invention includes a face plate having a central aperture alignable with an opening defined by respective elements to be joined, an anchoring assembly comprising a base portion and a support structure extending therefrom, and a positioner for axially moving the support structure of the anchoring assembly relative to the face plate.

The face plate has a front surface and a rear surface, the rear surface being positionable on a surface of either (1) a first structural element—wherein a second structural element may be attached to the face plate via one or more conventional fastening techniques such, for example, as the use of threaded screws, stud welded members, and the like or (2) a second structural element—wherein the first and second structural element have aligned through openings and are held together in a laminar or overlapping relationship between the apertured face plate and the anchoring assembly.

The support structure is a conical surface with an annular base. In general a cone is formed by the locus of lines from a point (its apex) to a planar curve defining its base. The cone may be circular, elliptical, pyramidal, etc. Although a right cone is preferred, where the apex is above the centroid of the base, that is not required. Once in place, the support structure projects from the base portion in an axial direction toward the interior surface of the first structural element, thereby preventing its removal.

The positioner is dimensioned and arranged to extend from the base portion in a direction axially aligned with the face plate aperture. A pulling force may thereby be exerted on the anchoring assembly via the positioner such that the anchoring assembly is moved into a final position in which the support structure engages surface regions of the first structural element opposed to the surface upon which the face plate is positioned.

The support structure of the anchoring assembly is dimensioned and arranged to impart, upon complete actuation of the positioner, joining forces on an interior surface of the first structural element at the base of the cone radially equidistant regions isolated from the peripheral edge of the opening without imparting forces on the interior surface of the second structural element at any point between an edge of the opening and the radially equidistant regions. The support structure of the anchoring assembly is sufficiently rigid as to resist continued movement of the base portion toward the face plate when distal regions of the support structure, i.e. the base of the cone, initially contact the first structural element—despite continued exertion of pulling forced on the anchoring assembly by the positioner. Joining forces are exerted by these same distal regions, and the support structure is sufficiently rigid as to prevent displacement of the distal regions from their initial positions of contact with the first structural element despite continued exertion of pulling forces on the anchoring assembly by the positioner.

The various features of novelty which characterize the invention are pointed out with particularity in the claims annexed to and forming part of the disclosure. For a better understanding of the invention, its operating advantages, and specific objects obtained by its use, reference should be had to the accompanying drawings and descriptive matter in which there are illustrated and described several embodiments of the invention.

### BRIEF DESCRIPTION OF THE DRAWINGS

The various objects and advantages of the invention will be apparent from the detailed description and claims when read in conjunction with the accompanying drawings wherein:

FIG. 1 is an exploded perspective view of a fastener assembly constructed in accordance with an illustrative embodiment of the present invention;

FIG. 2 is a side elevation view depicting the fastener of FIG. 1 during installation, showing contact of the support structure distal regions with the interior surface.

FIG. 3 is a side elevation view depicting the fastener of FIG. 1 in the final installed position;

FIG. 4 is a front elevation view showing the external appearance of the fastener of FIGS. 1-3 as installed, with the radially distributed regions of contact with the interior surface of a wall.

FIG. 5 is an exploded perspective view of an alternate embodiment of the present invention.

### DETAILED DESCRIPTION OF THE INVENTION

In the description which follows, like parts are marked throughout the specification and drawings, respectively. The drawings are not necessarily to scale and in some instances proportions have been exaggerated in order to more clearly depict certain features of the invention.

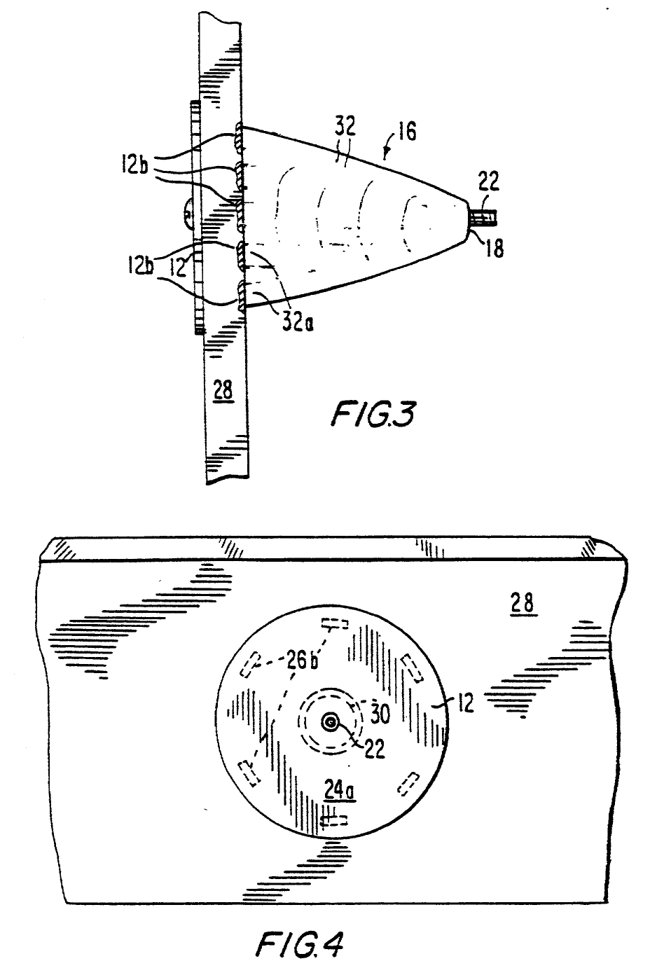

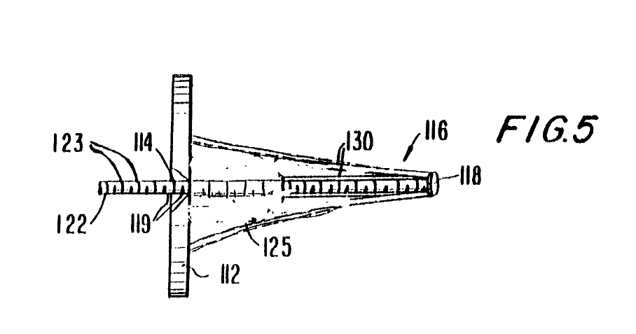

With initial reference to FIGS. 1-4, there is shown a fastener assembly constructed in accordance with an illustrative embodiment of the present invention. As best seen in FIG. 1, fastener assembly 10 includes a thin face plate 12 having a central aperture 14, an anchoring assembly 16 dimensioned for insertion into and through an opening and comprising a base portion 18 and a support structure 20 extending therefrom, and a positioner 22 for axially moving the support structure 20 of the anchoring assembly 16 relative to the face plate 12.

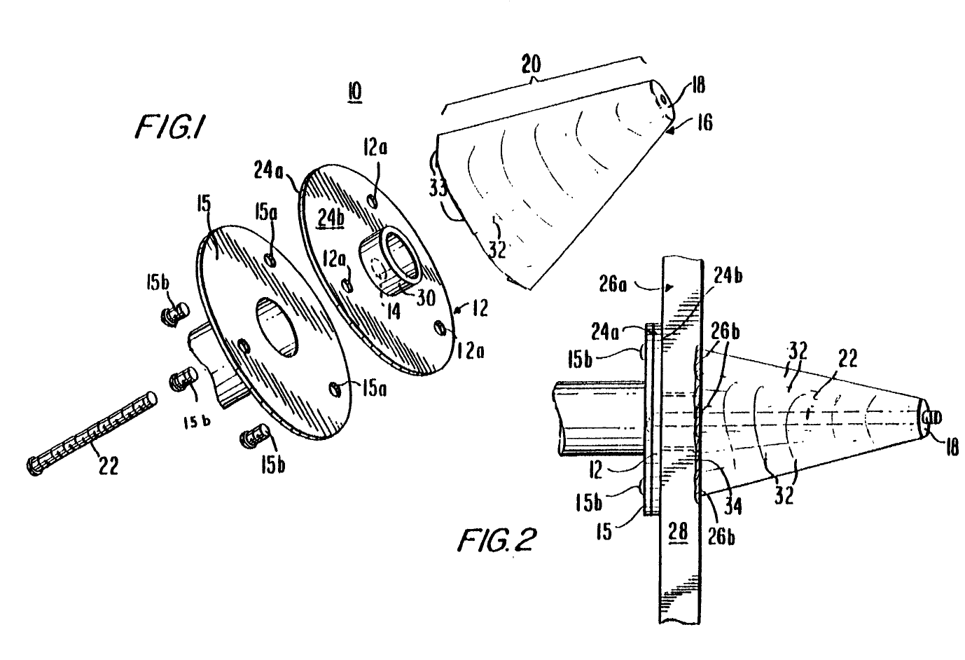

Face plate 12 has a front surface 24a and a rear surface 24b, the rear surface being positionable on a surface of either (1) a first structural element—wherein a second structural element may be attached to the face plate via one or more conventional fastening techniques such, for example, as the use of threaded screws, stud welded members, and the like or (2) a second structural element—wherein the first and second structural element have aligned through openings and are held together in a laminar or overlapping relationship between the apertured face plate and the anchoring assembly. In the illustrative installation depicted in FIGS. 2-3, the fastener assembly 10 is shown as being employed in the former application, with rear surface 24b overlying exterior surface 26a of a single panel member 28 and with central aperture 14 being aligned with a hole 29 previously formed, as by drilling or other operation. As best seen in FIG. 1, a tubular spacer element 30 extending from rear surface 24b of face plate 12 may be employed to prevent shifting of the faceplate relative to the hole and to thereby ensure precise alignment of the anchoring assembly 16 during installation. For this purpose, the cross sectional profile of spacer element 30 should be selected so that it closely corresponds to that of preformed hole 29.

It is also preferred to dispense with the tubular spacer 30 for less heavy loads and to reduce the size of the hole to that sufficient to accommodate the positioner 22.

The face plate 12 is maintained in the position shown in FIGS. 2-4 by anchoring assembly 16. Thus, and as best seen in FIGS. 2 and 3, once the anchoring assembly 16 is in place, the support structure 20 projects from the base portion 18 in an axial direction toward the interior surface of a first structural element as, for example, toward interior surface 26b of single panel 28, to thereby prevent its removal.

Although a wide variety of anchoring assembly configurations may be employed in the practice of the present invention, only a few representative examples of these will be discussed in detail herein. In the illustrative embodiment of FIGS. 1-4, the support structure 20 of anchoring assembly 16 comprises a cone that extend from apex portion 18 in a direction toward the rear or interior surface of face plate 12.

Fastener 10 further includes a positioning element 22 that is dimensioned and arranged to extend, upon placement of the anchoring assembly against a structural element, from the apex portion 18 in a direction axially aligned with the face plate aperture. A pulling force may thereby be exerted on the anchoring assembly 16 via the positioning element 22 such that the anchoring assembly 16 is moved into the intermediate and final positions of FIGS. 2-3, respectively. In the illustrative embodiment of FIGS. 1-4, positioning element 22 comprises a threaded member and the apex portion 18 of anchoring assembly 16 defines a central aperture correspondingly threaded to receive the threaded positioning element 22.

As will be readily appreciated by those skilled in the art, as threaded positioning element 22 is rotated, the anchoring assembly 16 is drawn closer to face plate 12 until the base of the cone of anchoring assembly 16 contact corresponding interior surface regions 26b of the first structural element 28. Spinning of the anchoring assembly 16 during installation may, for example, be prevented by applying a pulling force to the positioning element 22 as it is rotated.

Advantageously, the regions of contact between the cone base 32a of the support structure 20 are radially equidistant, that is, symmetrically arranged relative to the center of the opening, so that joining forces are exerted at evenly distributed locations remote from the edge of the opening. This is achieved with a circular cone, although other cones are possible. The support structure 20 of the anchoring assembly 16 is thus dimensioned and arranged to impart, joining forces on the interior surface of the first structural element 28 at the base of the cone isolated from the peripheral edge of the opening 29, without imparting forces on the interior surface of the first element at any point between an edge of the opening and the radially equidistant regions. In this manner, stress concentrations at the edges of the aligned openings are avoided and more relaxed tolerances are made possible.

According to the present invention, the support structure 20 of the anchoring assembly 16 is sufficiently rigid as to resist continued movement of the apex portion 18 toward the face plate 12 when distal regions, as regions 32a of the support structure 20, initially contact the first structural element, despite continued actuation of the positioning element 22. Joining forces are exerted by these same distal regions of the support structure, with the support structure also being sufficiently rigid as to prevent displacement of the distal regions from their initial positions of contact with the first structural element (FIG. 2) despite continued actuation of the positioning element 22. Thus, although continued actuation of the positioning element may produce a small amount of bending in conical surface 32 after the position in FIG. 2 is reached (as suggested in the final position depicted in FIG. 3), annular portions 32a do not move from their initial points of contact 26b. It will therefore be readily appreciated by those skilled in the art that the flattening of the anchoring member that is characteristic of conventional fasteners, and which disadvantageously results in a concentration of forces in the area immediately adjacent to the hole, does not occur in the anchoring assembly of the present invention.

In the absence of a strong second structural member interposed between face plate 12 and cone 32 of anchoring assembly 16,the outside diameter (or minimum dimension) of face plate 12 is preferably (although not necessarily) selected so that the base of cone 32 of anchoring assembly 16 does not extend beyond the peripheral edge(s) thereof. This arrangement distributes stresses only over those portions of the surrounding wall which are in compression—providing substantially enhanced mechanical strength and stability. Where the fastener of the present invention is employed to secure a large, rigid, second structural member to the first structural member, the cone base may extend beyond face plate 12. Indeed, the structurally rigid second member may itself be considered an extension of the face plate in that the two components together may serve to distribute forces over a much greater area than face plate 12 alone. Thus, for example, the fastener of the present invention maybe employed to secure a rail or similar structure to a prefabricated shower wall.

It will be readily appreciated by those skilled in the art that the fastener assembly of the present invention may be fabricated from any material having sufficient shear strength to withstand reasonable weights and loads secured to face plate 12 or held between the face plate and a structural member as panel member 28. The fasteners of the configuration depicted in FIGS. 1-4 may be formed with a stainless steel face plate of 2.875 inches in diameter and 0.1875 inches in thickness and a stamped anchoring assembly of half-hardened stainless steel 0.030 inches thick. It is contemplated that a variety of other materials such, for example, as polyethylene, glass reinforced nylon, graphite composites may also be employed, depending upon the specific application. For smaller units polyethylene is preferred.

The particular benefit of the conical configuration for supporting weight will now be explained. Where the base of the cone makes an angle θ with generators of the cone, and the coefficient of static friction between the base of the cone and the surface it contacts is μ, it can be shown that no lateral force can cause the cone to begin to slide along the wall if tan θ>1/μ. Thus for sufficiently large θ the conical element will not slide and a lateral force will have to break the fastener before the weight will fall.

With reference now to FIGS. 5, it will be seen that various modifications and alternate configurations of the fastener assembly of the present invention are possible. In the embodiment of FIG. 5, for example, the positioning element 122 extends from the center of the apex portion 118 of anchoring assembly 116 and is attached, coupled or integrally formed therewith. The positioning element 122 is configured in the manner of a wire tie and comprises an elongated member with a series of spaced serrations 123. Faceplate 112 is similar in construction to face plate 12 of FIGS. 1-4, but is modified to include a series of serrations 119 within central aperture 114. The anchoring assembly 116 is brought up to the wall and positioning element is merely pulled through the central aperture 114 of faceplate 112, until the final position is reached.

In view of the foregoing, it is obvious that many changes in and additions to the above described illustrative embodiments maybe made without departing from the nature, spirit, and scope of the invention, and that the invention is not limited to said details except as set forth in the appended claims:

I claim:

1. A fastener assembly for joining a first structural element to a second structural element, comprising an apertured face plate, an anchoring assembly, and a positioner for causing relative axial movement between the face plate and the anchoring assembly, said anchoring assembly includes a base portion and a projecting portion that extends in an axial direction away from the base portion, said projecting portion of the anchoring assembly being sufficiently rigid as to restrict further movement of the base portion toward the face plate when the projecting portion initially contacts the first structural element, despite continued actuation of the positioner, and said projecting portion is sufficiently rigid as to prevent displacement of distal regions of the anchoring assembly from respective initial positions of contact with the radially equidistant regions on the first structural element—despite progressively increased exertion of a pulling force on the anchoring assembly by the positioner.
